(19) United States
(12) Patent Application Publication
(10) Pub. No.: US 2026/0220497 A1
(43) Pub. Date: Jul. 30, 2026

(54) CONTENT CREATION ENGINE

(71) Applicant: OTHELIA TECHNOLOGIES PTY LTD, Sydney, New South Wales (AU)

(72) Inventors: Joseph Couch, Sydney (AU); Claude Wicks-Green, Sydney (AU); Bosco Ho, Sydney (AU); Ben Boyle, Sydney (AU)

(73) Assignee: OTHELIA TECHNOLOGIES PTY LTD, Sydney, New South Wales (AU)

(21) Appl. No.: 19/142,108

(22) PCT Filed: Dec. 20, 2023
(86) PCT No.: PCT/AU2023/051340

§ 371 Date: Jun. 20, 2025

(30) Foreign Application Priority Data
Dec. 20, 2022 (AU) 2022903924

(51) Int. Cl. G06N 5/025

(52) U.S. Cl. CPC G06N 5/025

(57) ABSTRACT

Described herein is a method (100) of generating a narrative design framework. The method (100) including the initial step (101) of receiving a plurality of text strings corresponding to nouns indicative of components of the narrative design. At step (102), a noun database is populated with the text strings and each text string is associated with noun metadata including a text descriptor for the nouns, a unique noun identifier and a noun classification, wherein each text string and associated noun metadata collectively form a noun entry. At step (103), one or more data objects are created which correspond to events and/or goals and populating the one or more data objects with at least one of the noun entries to associate the noun entries with one or more events and/or goals. At step (104), in response to input from a user, linking one or more events and/or goals with other events and/or goals by creating a link ID and storing each link ID in metadata associated with the respective data objects corresponding with the one or more events and/or goals. Finally, at step (105), based on the linked events and/or goals, a narrative design framework for creating a narrative is generated.

### FIELD OF THE INVENTION

The present application relates to content creation and in particular to a method of generating a narrative design framework.

Embodiments of the present invention are particularly adapted for using computer systems for creating narratives for stories, movies, theatrical productions and video games. However, it will be appreciated that the invention is applicable in broader contexts and other applications.

### BACKGROUND

When creating a narrative project, much of the unique data is free text or otherwise unstructured. This creates challenges for procedural design and execution of narrative projects, in that quality output remains at the discretion of a human curator, rather than a procedural rule set. In particular, the creative nature of these projects makes them difficult to emulate in a computer architecture. Thus, there is a technical difficulty in computerising narrative projects.

The inventors have identified a need to better define and manage the suite of project-specific data for a creative project.

Any discussion of the background art throughout the specification should in no way be considered as an admission that such art is widely known or forms part of common general knowledge in the field.

### SUMMARY OF THE INVENTION

In accordance with a first aspect of the present invention, there is provided a method of generating a narrative design framework, the method including the steps:
receiving a plurality of text strings corresponding to nouns indicative of components of the narrative design;
populating a noun database with the text strings and associating each text string with noun metadata including a text descriptor for the nouns, a unique noun identifier and a noun classification, wherein each text string and associated noun metadata collectively form a noun entry;
creating one or more data objects corresponding to events and/or goals and populating the one or more data objects with at least one of the noun entries to associate the noun entries with one or more events and/or goals;
in response to input from a user, linking one or more events and/or goals with other events and/or goals by creating a link ID and storing each link ID in metadata associated with the respective data objects corresponding with the one or more events and/or goals; and
based on the linked events and/or goals, generating a narrative design framework for creating a narrative.

In some embodiments, the generated narrative design framework includes a structured text. In some embodiments, the linking of an event/goal with another event/goal generates a text sentence. In some embodiments, the structured text includes a series of linked text sentences.

In some embodiments, the generated narrative design framework includes a behaviour tree. In some embodiments, the generated narrative design framework includes a finite state machine. In some embodiments, the generated narrative design framework is in a form to be input to a Goal Oriented Action Planning system. In some embodiments, the generated narrative design framework is in a form to be input to a Hierarchical Task Network planning system.

Preferably at least some of the noun metadata is dynamically variable. Preferably at least some of the metadata associated with the respective data objects corresponding with the one or more events and/or goals (event/goal metadata) is dynamically variable.

In some embodiments, the method includes the step of inputting the narrative design framework to a rules engine which is configured to selectively adjust one or more of the dynamically variable noun metadata and/or event/goal metadata to update the narrative design framework.

In some embodiments, the rules engine selectively adjusts one or more of the dynamically variable noun metadata and/or event/goal metadata in response to user input. In some embodiments, the rules engine selectively adjusts one or more of the dynamically variable noun metadata and/or event/goal metadata based on a set of predefined rules or constraints.

In some embodiments, the components of the narrative design include one or more of characters, locations, populations, physical objects, or abstract concepts.

In some embodiments, the plurality of text strings are received via a text import process which imports text from a script and extracts nouns. In some embodiments, the plurality text strings corresponding to nouns are extracted from a file containing the script. In some embodiments, the file is a PDF file. In some embodiments, the plurality of text strings are entered by a user through a user interface.

In some embodiments, the method includes the step of displaying the narrative design framework on a display.

In some embodiments, the method includes the step of displaying the one or more events and/or goals associated with the narrative design framework on the display and selectively allowing user input to adjust a temporal order of events and/or a value of goals.

In some embodiments, the method includes the step of generating a visual representation of one or more characters in the form of a relational graph and illustrating the relative position of each character on the graph.

In some embodiments, the method includes the step of creating one or more noun links which link one or more of the noun entries.

In accordance with a second aspect of the present invention, there is provided anon-transitory machine-readable storage medium storing instructions that, when executed, perform the method according to the first aspect.

In accordance with a third aspect of the present invention, there is provided system including one or more processors and memory storing instructions that, when executed by the one or more processors, perform the method according to the first aspect.

### BRIEF DESCRIPTION OF THE FIGURES

Example embodiments of the disclosure will now be described, by way of example only, with reference to the accompanying drawings in which:

FIG. 1 is a process flow diagram illustrating the primary steps in a method of generating a narrative design framework;

FIG. 2A is a schematic diagram illustrating a computer system for performing the method of FIG. 1;

FIG. 2B is a schematic diagram illustrating the primary processing steps performed by the system of FIG. 2A in querying a database;

FIG. 3 is a functional block diagram illustrating the different processes that can be performed by the system of FIG. 2;

FIG. 4 illustrates three exemplary noun entry data structures having associated metadata;

FIG. 5 illustrates an exemplary noun link data table which links two noun entries together;

FIG. 6 illustrates an exemplary data object for an event that involves a subject and an object;

FIG. 7 illustrates an example linking of an event with a goal;

FIG. 8 illustrates a Gantt-style chart of goals;

FIG. 9 illustrates the drag and drop arrangement of goals through time;

FIG. 10 illustrates event relationships in a timeline view on a user interface;

FIG. 11 illustrates a graphical interface allowing dragging and dropping of events to goals;

FIG. 12 illustrates a graphical interface allowing the setting and changing of goal priority;

FIG. 13 illustrates an exemplary story summary interface in the form of a relational graph;

FIG. 14 is a schematic process flow diagram of a sequence of processes that a user may perform with the system of FIG. 2 to create a story output in the form of a narrative design framework; and

FIG. 15 is a schematic diagram illustrating the formulation of an exemplary event and the associated event metadata.

### DESCRIPTION OF THE INVENTION

Described herein is a method 100 of generating a narrative design framework. The narrative design framework represents a digital framework that embodies the core elements of a narrative. A narrative design framework is a data model which allows any narrative project to fully define the unique data for their project, without limiting or constraining the data requirements whilst still providing a metadata overlay across the data set that removes the need for analysis of unstructured text. It may include information relating to a treatment, synopsis or full script of a narrative. In some embodiments, the narrative design framework is in the form of a structured text output comprising one or more text strings containing a series of linked sentences and associated grammar that can be viewed by a user on a user interface. In other embodiments, the generated narrative design framework is in a machine readable format so as to be able to be input to a machine classifier or other machine learned system for applying rules or weightings to components of the narrative design. In some embodiments, the generated narrative design framework is in the form of one or both of a behaviour tree and/or a finite state machine. The narrative design framework may be input to a Goal Oriented Action Planning system or a Hierarchical Task Network planning system for developing a dynamic narrative.

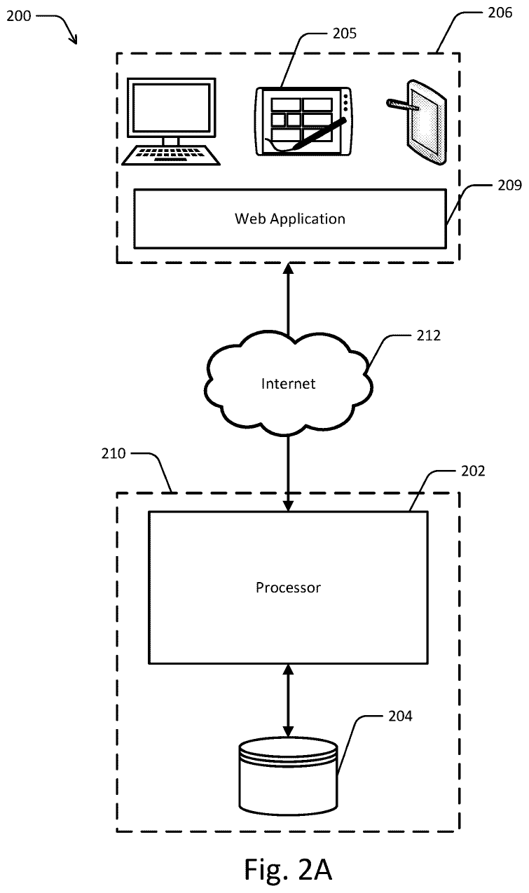

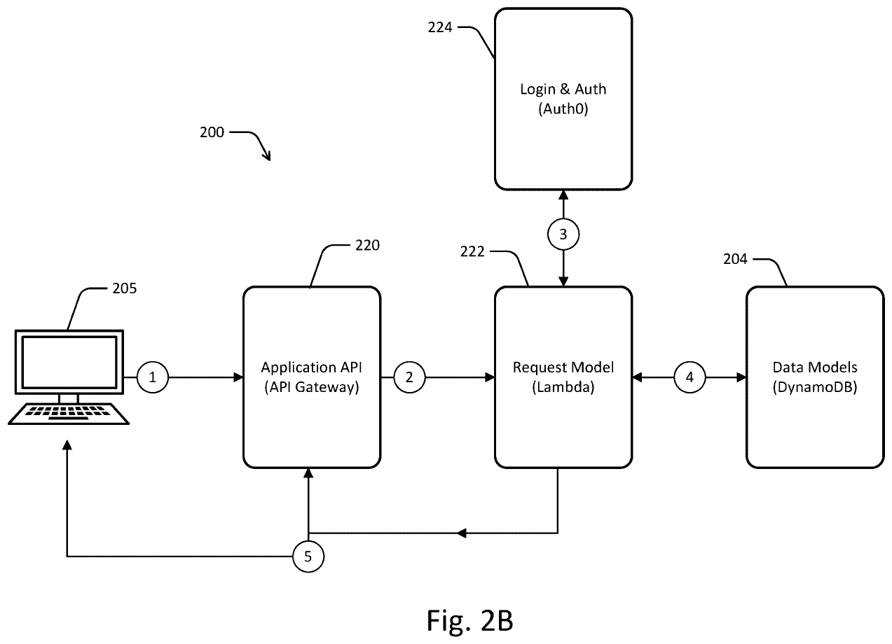

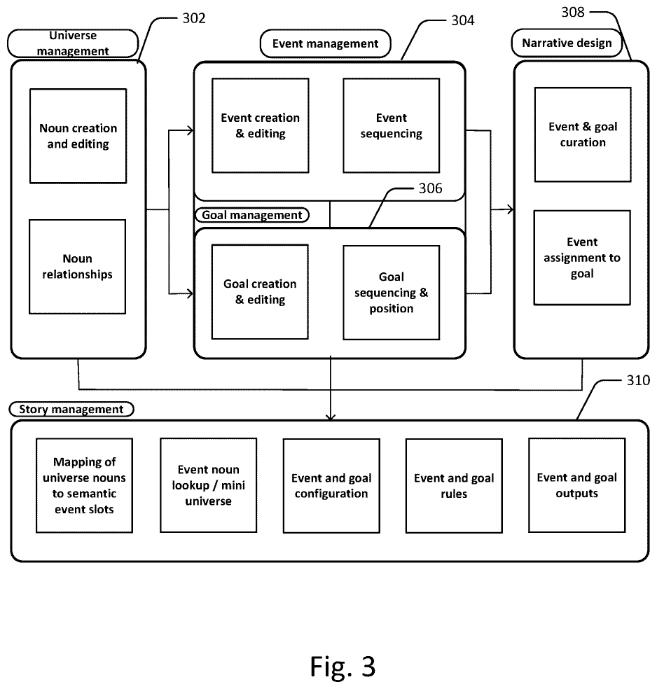

Referring to FIG. 2A, method 100 is implemented by a computer system 200 including one or more processors 202 and memory in the form of database 204 storing instructions that, when executed by the one or more processors 202, perform the method. Computer system 200 is adapted to perform a number of functions, outlined in FIG. 3, which will be described below. System 200 includes one or more local user devices 205 in the form of one or more of a personal computer, tablet computer or smartphone device. These devices 205 provide a user interface 206 which is configured to receive user input and communicate it to processor 202. The user interface 206 may include a web application 209 such as a web browser of software application configured to display data to the user. Processor 202 and database 204 are preferably hosted by a server 210 or serverless cloud infrastructure that is accessible by devices 205 over the internet 212.

FIG. 2A does not illustrate all functional or physical components of a computer processing system. It will also be appreciated that the particular type of computer processing system will determine the appropriate hardware and architecture, and alternative computer processing systems suitable for implementing features of the present disclosure may have additional, alternative, or fewer components than those depicted in FIG. 2A.

Referring now to FIG. 2B, the operation of system 200 is described to perform method 100. At initial step (1), the user submits a request to an API gateway 220 from the user interface of a device 205. By way of example, the API gateway 220 may host Representational State Transfer Application Programming Interfaces (or REST APIs). These are a set of rules and standards that allow different software applications to communicate with each other over the internet. This request may include a username, an authentication token (Auth0 token) and requested model (described below). At step (2), API gateway 220 executes a Lambda function 222 with input data and awaits a response. At step (3), the Lambda function 222 uses the username ant Auth0 token to perform a login 224 and get user access metadata (e.g. user group, allowed models). At step (4), the Lambda function 222 queries database 204, which may comprise a database service such as DynamoDB by Amazon Web Services, and extracts compressed data. Finally, at step (5), the Lambda function 222 returns to the API gateway 220, which returns the data to the user interface at device 205. The returned data is decompressed by software installed on device 205 such as a web application.

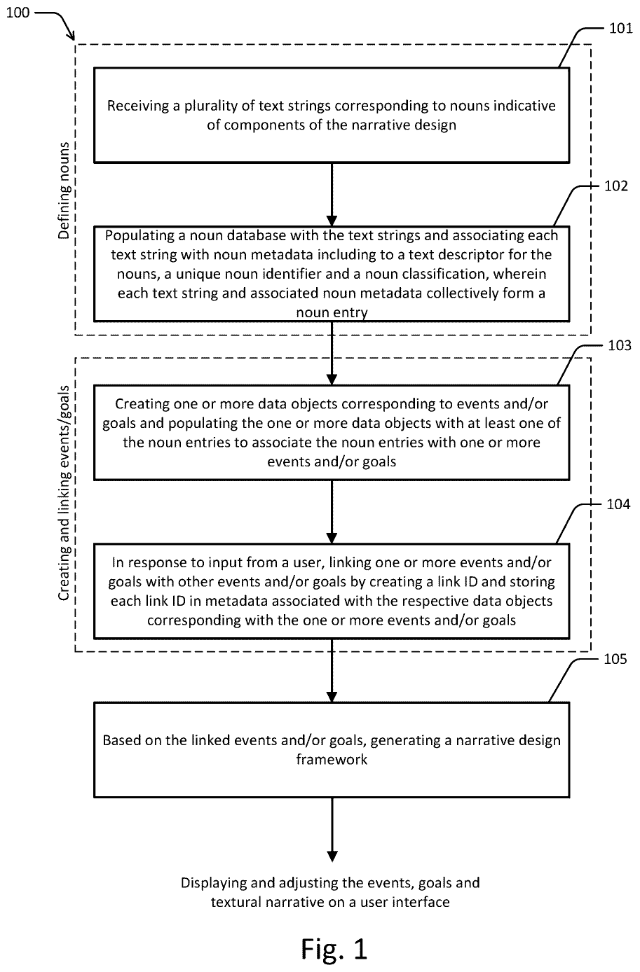

Referring again to FIG. 1, method 100 includes the initial step 101 of processor 202 receiving a plurality of text strings corresponding to nouns indicative of components of the narrative design. In some embodiments, the text strings may be entered directly by a user through user interface 206 or selected from a predefined list of nouns stored in database 204 via user interface 206. In other embodiments, the text strings corresponding to nouns are imported and extracted from a script or file containing a text of the narrative. By way of example, a PDF file may be imported and processed by processor 202 to extract text strings corresponding to identified nouns in the text of the PDF.

The components of the narrative design that are described by the nouns include characters, locations, populations (groups of characters), abstract concepts (e.g. peace, love), physical objects or assets (e.g. swords, factories), roles, resources, capabilities, environments, states, verb transformations, physical or emotional acts and other elements that can make up a narrative. In some embodiments, “Characters” and “Populations” are treated as primary nouns, and the remaining types are treated as secondary nouns. It will be appreciated that various other types of nouns may be defined depending on the particular application.

At step 102, a noun database, which may form part of database 204, is populated with the text strings entered at step 101 and each text string is associated with noun metadata. The noun database has a bespoke data structure which represents a general narrative data model. The association is made via the user interface presenting the user with a number of free-text fields plus associated metadata, some of which is type specific. Once the user enters the fields and selects the metadata, this data is pushed as part of the request via the API gateway 220 to query database 204.

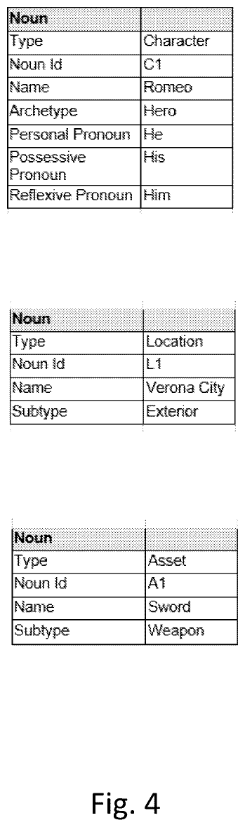

The noun metadata includes at least a text descriptor for the nouns, a unique noun identifier and a noun classification. Each text string and associated noun metadata collectively form a “noun entry” in the noun database. Exemplary noun entries are illustrated in FIG. 4, wherein the text descriptor is the “Name” entry, the unique noun identifier is the “Noun Id” and the noun classification includes a “Type” plus optional other classifications such as “Archetype”, “Personal Pronoun”, “Possessive Pronoun”, “Reflexive Pronoun” and “Subtype”. Nouns are preferably stored in separate datasets in the same structure. In some embodiments, the noun database is an unstructured database.

Noun metadata may also include data allocation tags in the form of “internal”, “external” or “adjacent” to define a relationship to a noun population within a narrative. The tag “internal” defines that the noun is internal to a population, while the tag “external” defines that the noun is external to a population. By way of example, the character Romeo is internal to the population Montague while the character Juliet is external to the population Montague but internal to the population Capulet. The tag “adjacent” can be used to define a more abstract related relationship such as a buddy, sidekick or love interest in a narrative who is neither internal nor external to a character.

These data allocation tags are fundamental to the data structure of the nouns. The relationships provided by the data allocation tags are a primary mechanism to create a semantic overlay on an unstructured set of nouns. In other words, once a noun is allocated to one of these data allocation tags, it “exists” in the narrative. Before that it's just a wandering asset which isn't useable for narrative.

From a data management point of view, these data allocation tags are useful for organising and sorting semantic data and allow rules to be defined for nouns such as characters.

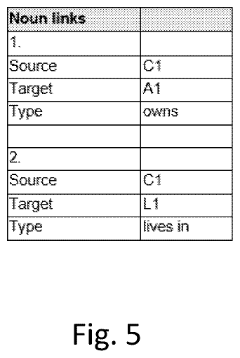

The noun metadata may also include one or more noun links which link one or more of the noun entries to other noun entries. Referring to FIG. 5, there is illustrated an exemplary noun link data table showing links between sources (in this case characters) and targets. Noun link 1 defines an ownership type link attribute between character C1 (Romeo—see FIG. 4) and asset A1 (sword—see FIG. 4). Noun link 2 defines a location type attribute between character C1 and location L1 (Verona City—See FIG. 4) to indicate that Romeo lives in Verona City. Similar links can be established between other noun entries.

The various noun metadata may be predefined and included as constraints when a new noun is entered or selected by a user. In other words, when a user selects a noun to use, user may be presented with a list of predefined noun metadata to select which will be associated with that noun.

At step 103 of method 100, one or more data objects corresponding to events and/or goals are created. In some embodiments, the event/goal data objects are stored in a separate database or file such as a JSON (JavaScript Object Notation) file to the noun data. A JSON file is a lightweight language-independent data-interchange format that is easy for humans to read and write and easy for machines to parse and generate. The event/goal data objects are populated with metadata linking at least one of the noun entries to associate the noun entries with one or more events and/or goals for the narrative. In the JSON format, the event/goal data and metadata may be stored as a collection of name/value pairs in the form of an object, record, struct, dictionary, hash table, keyed list, or associative array. The values may be organised into an ordered list of values, which may be realised as an array, vector, list, or sequence.

Where the user interface 206 includes a web client (e.g. web browser application), the JSON file may be retrieved from processor 202 in the form of a server to (via a query) where it can be processed by the web client using JavaScript or another client-side language.

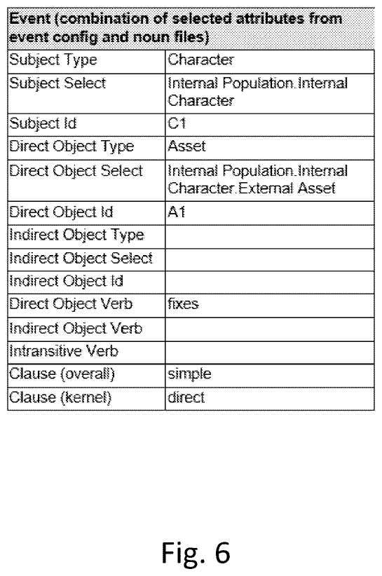

FIG. 6 illustrates an exemplary data object that relates to an event that involves a subject (in this case Character C1) and an object (in this case a sword A1 sword). The various attributes of each goal or event are included in the data object as goal metadata or event metadata. Although not shown, the goal/event metadata incudes other attributes such as link identifiers to link goals and events together (described below), start time and duration of events/goals, priorities or hierarchies of events/goals and a publication status indicating whether or not the goal/event is to be published as an output. It will be appreciated that various other attributes can be included in the goal/event metadata. The data objects for events and/or goals are stored in database 204.

An example set of metadata for a goal data object includes:
Goal ID—unique identifier for the goal such as a text name of the goal;
Linked nouns—Link IDs to one or more nouns (characters, assets, locations etc.) associated with the goal;
Start time—a numerical value indicating a start time of the goal;
Duration—a numerical value indicating a duration of the goal;
Hierarchy—contains link IDs to parent (higher order) or child (lower order) goals;
Linked events—Link IDs to link the goal with one or more events;
Verb metadata—data defining one or more actions for the goal;
Publication flag—a binary value indicating whether or not the goal should be published and included in the narrative design framework.

An example set of metadata for an event data object includes:
Event ID—unique identifier for the event such as a text name of the event;
Linked nouns—Link IDs to one or more nouns (characters, assets, locations etc.) associated with the event;
Event sequence value—a numerical value indicating a position of the event in a temporal sequence of events (e.g. a number from 1 to 100 if there are 100 events in the narrative);
Cause and effect links—“source” or “target” flags to link with another event to indicate whether the other event is a cause of this event or an effect of this event;
Hierarchy—contains link IDs to parent (higher order) or child (lower order) events;
Linked goals—Link IDs to link the event with one or more goals;
Verb metadata—data defining one or more actions for the event;
Publication flag—a binary value indicating whether or not the event should be published and included in the narrative design framework.

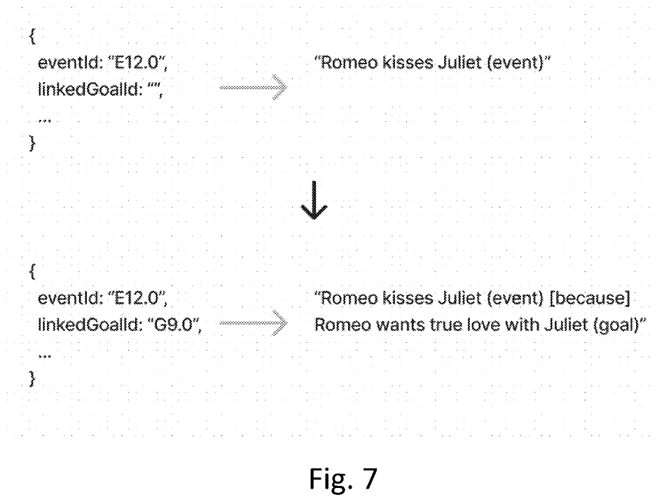

At step 104, in response to input from a user, one or more events and/or goals are linked with other events and/or goals. This linking process is performed by creating one or more link IDs and storing each link ID as metadata associated with the respective data objects corresponding with the one or more events and/or goals. For example, a goal ID can be stored as a link in an event metadata and vice versa. The link ID is preferably in the form of a text string. FIG. 7 illustrates an example linking of an event with a goal. The event has an event ID of “E12.0” and this is linked with the goal through the link ID “G9.0”. Prior to linking, when an event/goal is created the link ID metadata field may be empty or populated with a default text string indicative of no active links.

The process of allocating an event in the narrative journey creates a linked goal ID as illustrated in FIG. 7. The data changes associated with this linked goal ID are passed from the user device 205 to the database 204 via the process illustrated in FIG. 2B using the API gateway 220. This then updates parts of the project JSON file to create a new, updated set of relationships. The process may be repeated for different goals and/or events.

A hierarchy of events and goals can also be established by setting a “parentGoalID” metadata field or “childGoalID” of a goal or “parentEventID” metadata field or “childEventID” of an event. These fields can be populated with the unique identifier for another goal/event to indicate that the goal/event is higher (for parent goals/events) or lower (for child goals/events) in the hierarchy than the selected goal/event. In other words a goal/event becomes a sub-goal or a sub-event to the parent goal/event. This process can be repeated to define tiers of goals/events in a hierarchy.

As illustrated in FIG. 7, the linking of an event/goal with another event/goal generates a text sentence. This linking process is performed by an event management module 204 and/or a goal management module 306, which are described below and illustrated in FIG. 3. The stitching together of goals and events is performed by a story management module 310, also described below and illustrated in FIG. 3.

In the illustrated example, the event “Romeo kisses Juliet” is linked with the goal of Romeo wanting true love with Juliet to produce a text sentence “Romeo kisses Juliet because Romeo wants true love with Juliet”. If an event has a linked goal ID, the event and goal can be displayed together as a combined string of text. Upon linking a goal with an event, an attribute “linkedGoalID” is populated with a corresponding goal ID, providing a look up to that goal's data and text output.

Some simple goal and event examples include:
Simple state: Eddard Stark acts=<Subject.Name> <Intransitive.Verb>
Simple direct: Eddard Stark executes Sansa Stark's dire wolf=<Subject.Name> <Dirobject.Verb> <Dirobject.Name>
Simple indirect: Eddard Stark puts Sansa Stark's dire wolf to death=<Subject.Name> <Indirobject.Verb> <Dirobject.Name> <Indirobject.Preposition> <Indirobject.Name>
A more advanced event example is “Cersei Lannister promises Joffrey Lannister that Robert Baratheon orders Eddard Stark to put Sansa Stark's dire wolf to death”:
<Decider.Name> <Decider.Verb> <Beneficiary.Name> <Secondary.Clause.Preposition> <Delegate.Name> <Delegate.Verb> <Subject.Name> <Delegate.Preposition> <Indirobject.Verb> <Dirobject.Name> <Indirobject.Preposition> <Indirobject.Name>

At step 105, based on the linked events and/or goals, a narrative design framework is generated, which can be used for creating a narrative. The generated narrative design framework is stored on database 204, preferably as one or more JSON files. As mentioned above, the output narrative design framework may be in a human readable form and/or in a machine readable form. In a human readable form, the narrative design framework can take the form of a structured text output containing a series of linked sentences and associated grammar that can be viewed by a user on user interface 206. For machine readable outputs, the narrative design framework can take a number of forms, including a behaviour tree, a finite state machine, a combination thereof or other rule-based output. In some embodiments, the narrative design framework is in a form such that it can be input to a Goal Oriented Action Planning system or a Hierarchical Task Network planning system. These machine readable input forms are useful where the narrative is intended to be used in a video game engine to generate a narrative for the video game.

Once the narrative design framework has been initially defined, it can be dynamically varied in a number of ways. For example, the narrative design framework can be modified through user input at user interface 206. Preferably at least some of the noun metadata and/or the metadata associated with the respective data objects corresponding with the one or more events and/or goals (event/goal metadata) are dynamically variable. By way of example, the relationships between different noun entries can be changed by modifying respective noun links in the noun metadata. Similarly, noun entries can be associated with different goals/events by adding noun entries or the associated noun metadata to the data objects of the relevant goals/events. In addition, goals and events can be dynamically linked by selectively modifying the respective link IDs. In some embodiments, the interface can selectively allow user input to adjust a temporal sequence of events and goals, and/or a value of goals. In some embodiments, event sequencing can be performed in part by defining a cause and effect relationship between events. Defining a first event as a “source” and a second event as a “target” using metadata tags links the two events and places the second event after the first event.

Modifications as outlined above are achieved by a new query from a user through the user interface 206 by following the process outlined in FIG. 2B. The importance of the narrative design chart and goal cascade interfaces is that it allows intuitive user interactions to create new linkages or edit old linkages. These changes are then saved back in the database using the relevant API gateway 220.

Sequencing of goals can occur by populating a start time and duration metadata field in the goal metadata. Sequencing of events can occur by populating an event sequence value metadata field in the event metadata. This is a numerical value indicating a position of the event in a temporal sequence of events of the narrative (e.g. a number from 1 to 100 if there are 100 events in the narrative).

Preferably the dynamic variations are applied by the narrative design framework being input to a rules engine which is configured to selectively adjust one or more of the dynamically variable noun metadata and/or event/object metadata to update the narrative design framework. The rules engine is realised as an algorithm that is executed by processor 202 and sends and receives data to/from user interface 206. The rules engine is responsive to user input to selectively adjust one or more of the dynamically variable noun metadata and/or event/goal metadata based on a set of predefined rules or constraints. In addition to adjusting the noun metadata and event/goal metadata, new noun entries and new events and goals may be created through user interface 206. The rules engine allows linkages and event or goal design to be changed based on rule sets by operating on metadata directly.

User interface 206 preferably includes a graphical interface for graphically displaying elements of the narrative design framework. In some embodiments, user interface 206 includes a drag and drop functionality on a graphical interface wherein the rules engine is responsive to the location (e.g. pixel position) of objects (e.g. events/goals and nouns) on the interface. This allows a user to graphically drag and drop goals and events over time and define goal hierarchies including series, parallel and nested relationships, select goals for “publishing” to a narrative design view and perform scheduling of goals and events. Nouns such as characters, objects and locations can also be linked to various events/goals through a drag and drop process.

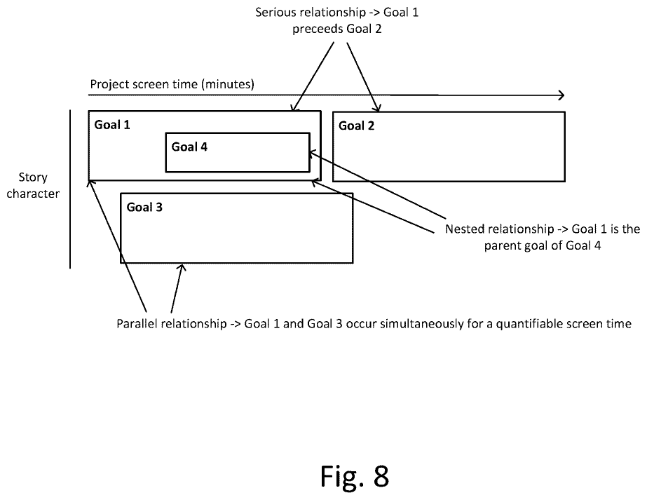

FIGS. 8 to 13 illustrate exemplary graphical interfaces that may be rendered on user interface 206. FIG. 8 illustrates a Gantt-style chart of goals wherein user interactions via user interface 206 allow the setting of “start time”, “duration” and “parentGoalID” attributes via the dragging of elements and input fields on user interface 206. In other words, graphical manipulation of goals on user interface 206 allows for dynamically varying the goal metadata in the database. Goals can be assigned a “parentGoalID” to nest that goal within another goal. “start time” and “duration” attributes can be changed via graphical movement of objects by a user to reflect the goal's position and dimensions in the chart. In FIGS. 8 to 10, the height of the goals and events represent their complexity. If an event has a series of nested child events, then it is more complex than a standalone event.

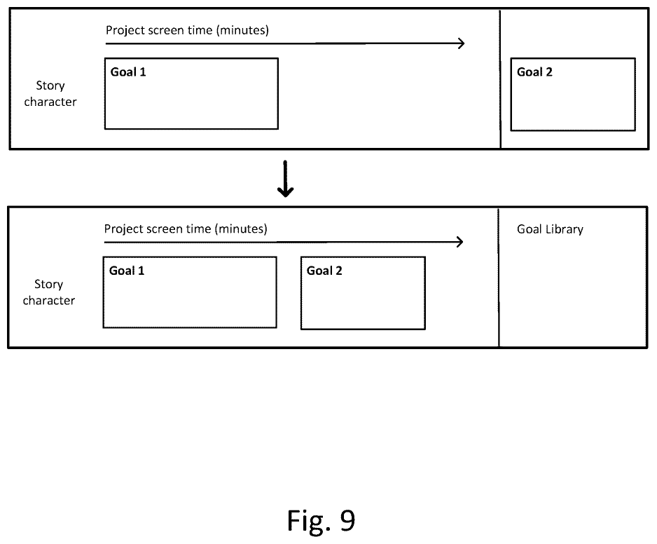

FIG. 9 illustrates the drag and drop arrangement of goals through time to demonstrate story complexity by visually representing goals in a Gantt chart schedule. A user is able to drag a goal from a library of goals stored in database 204 into the Gantt chart rendered on the graphical interface. Upon dropping the goal at a desired location, the goal becomes “published” and is given attributes for “start time” and “duration”.

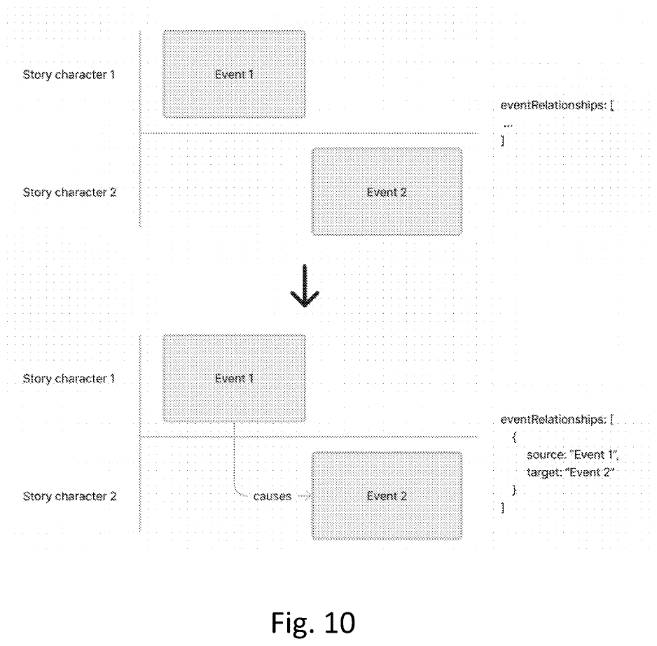

FIG. 10 illustrates event relationships in a timeline view on user interface 206. This graphical interface allows a user to visually connect a line from one event (the causal event) to another event (the effect event) in a timeline style diagram. This creates a cause and effect relationship between the events. As mentioned above, cause and effect can be established through the activation of “source” “target” metadata tags in the event data object. Users can also reorder events and goals via user interface 206.

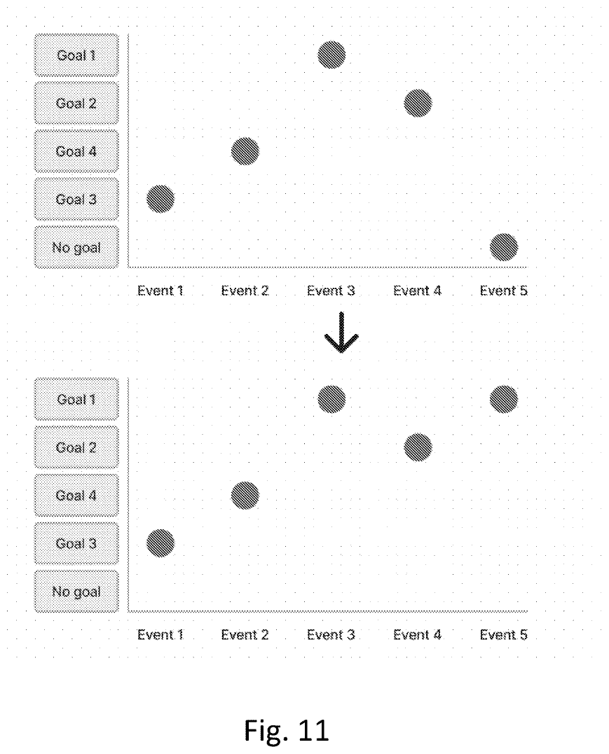

FIG. 11 illustrates a graphical interface allowing dragging and dropping of events to goals. Dragging a shape (representing an event) in a line chart style visualisation to a point along a y axis of goals modifies the “linkedGoalID” attribute of the event to reflect the value of the y axis to which it was dragged.

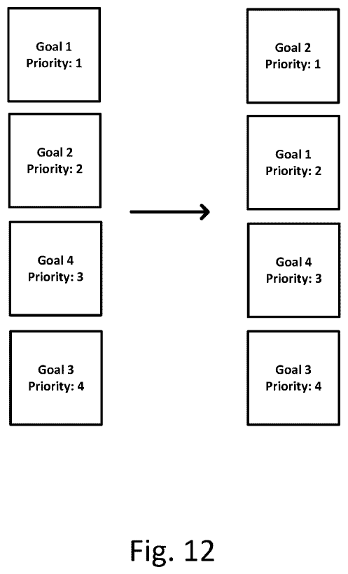

FIG. 12 illustrates a graphical interface allowing the setting and changing of goal priority. A list of goals is displayed, each with a “priority” value and a user is able to drag a goal box to re-order the list. The graphical reordering modifies the “priority” attributes that are stored in the goal metadata. The priority is the same concept as the hierarchy described above. A similar prioritisation or hierarchy can be formulated for events.

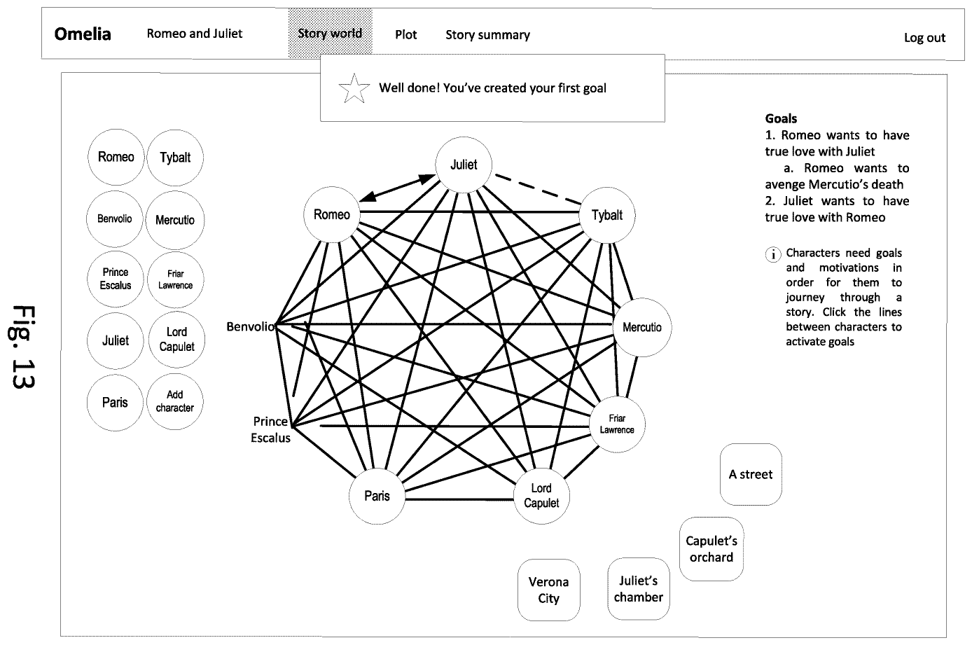

FIG. 13 illustrates an exemplary story summary interface in the form of a relational graph. The interface displays a plurality of characters (in this case from the story of Romeo and Juliet) which are positioned relative to each other to illustrate their relationships and proximity to other characters. When presented on user interface 206, the story summary interface is interactive and a user can manipulate the connections between characters to vary the narrative design framework.

Referring again to FIG. 3, system 200 supports a number of functions as described above. Within a universe management module 302, system 200 allows the creation and editing of nouns using the noun database described above. Nouns can be imported from a file such as a text or PDF file and stored in the noun database as noun entries with associated noun metadata. The import function includes a file opening function, noun text string identification, noun extraction and text copying to the noun database. Nouns can also be created by entering them manually from a user via user interface 206. User interface 206 also allows for the editing of existing nouns in the noun database.

The universe management module 302 also performs the creation and management of noun relationships. Creating noun relationships is performed by creating links in the noun metadata of a noun entry stored in the noun database. By way of example, a person (primary noun) may own, possess or carry a sword (secondary noun). This ownership is established by creating a noun link in the noun metadata as illustrated in FIG. 5 and described above.

An event management module 304 is responsible for creating and editing events and performing event sequencing. Event creation includes the population of event data objects with corresponding metadata as described above. Event sequencing allows for defining the ordering of events through time and to attach cause & effect dependencies between events to illustrate sub plots. Two interfaces enable the defining of a timeline of events: a “board”; and a “timeline”. The timeline is a detailed sequencer to visually demonstrate plot relationships, whilst the board is a higher level brainstorm site to define what happens in each episode.

A goal management module 306 is responsible for creation, editing and sequencing of goals. Goal creation includes the population of goal data objects with corresponding metadata as described above. Goal sequencing and hierarchy allows defining the relationship between one goal and another, and sequence the goals across the act structure of a narrative. Clustering and sequencing of goals is possible using series, parallel and nested relationships. The user interface 206 allows drag and drop arrangement of goals through time to demonstrate story complexity visually turning goals into a Gantt chart.

A narrative design module 308 is responsible for event and goal curation, and assignment of events to goals using link ID metadata tags. Narrative design module 308 is responsible for “pinning” events to goals and curating the events and goals which will be expressed in a published story design. This is the “assembly” phase of the story in which the different components are put together in a way which becomes a design for the first time.

A story management module 310 receives inputs from the universe management module 302, event management module 304, goal management module 306 and narrative design module 308 to perform a number of functions. Primarily, story management module 310 hosts the rules engine to allow abstracted sets of rules or constraints to be defined by a user (such as a game or VR designer), such that stories emerge procedurally as the narrative design framework. Once the TV or film story is designed, the rules engine allows the story to be organically moulded or shaped according to certain rules.

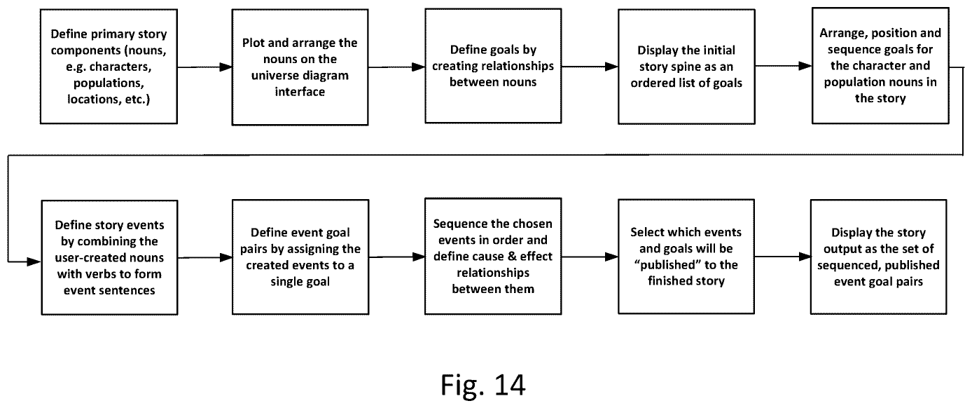

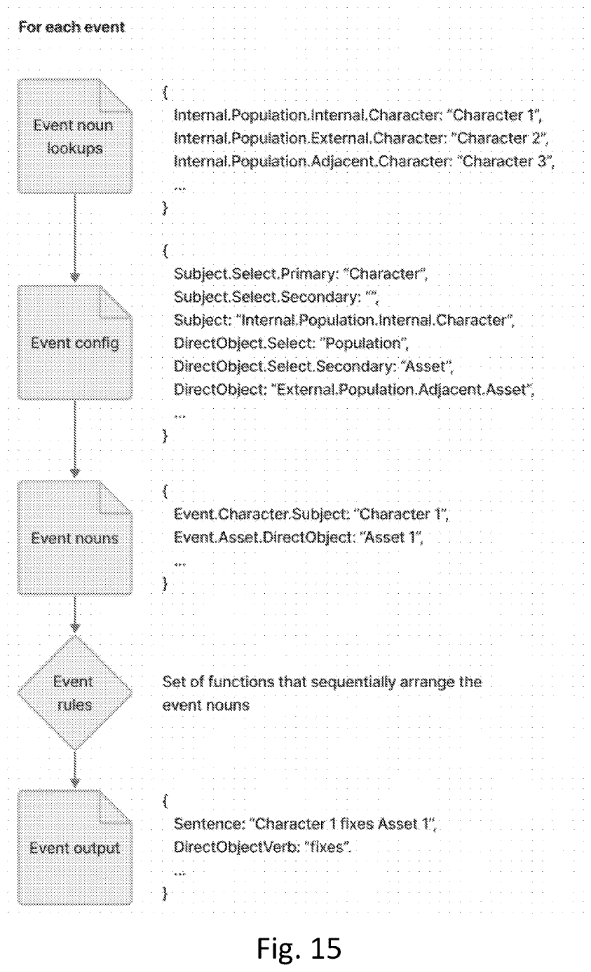

FIG. 14 illustrates schematically a sequence of processes that a user may perform with system 200 to create a story output in the form of a narrative design framework. FIG. 15 illustrates schematically the formulation of an exemplary event and the associated event metadata.

In each of the above described operations involving queries from a user, control signals are transmitted from user devices 205 through the interned 212 to remote server 210 (or cloud infrastructure) and database 204. These signals instruct the server or cloud infrastructure to extract or parse data stored in the database and generate return signals containing subset of the data in the form of data objects.

In this manner, data related to the user's project(s) are transmitted to the local devices 205 when requested by the user interface/web application, including the story universe, nouns, narrative rules, events, goals, verb model data, noun model data. During normal operation, most of the data is stored remotely in the database.

The above described invention is advantageous in providing a software solution for defining and managing the suite of information needed for a creative project. This allows the software to focus creatives on decisions that matter to the project quality.

### Interpretation

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “controller” or “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

Reference throughout this specification to “one embodiment”, “some embodiments” or “an embodiment” means that a particular feature, structure or characteristic described in connection with the embodiment is included in at least one embodiment of the present disclosure. Thus, appearances of the phrases “in one embodiment”, “in some embodiments” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

It should be appreciated that in the above description of exemplary embodiments of the disclosure, various features of the disclosure are sometimes grouped together in a single embodiment, Fig., or description thereof for the purpose of streamlining the disclosure and aiding in the understanding of one or more of the various inventive aspects. This method of disclosure, however, is not to be interpreted as reflecting an intention that the claims require more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those skilled in the art. For example, in the following claims, any of the claimed embodiments can be used in any combination.

In the description provided herein, numerous specific details are set forth. However, it is understood that embodiments of the disclosure may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical, electrical or optical contact, or that two or more elements are not in direct contact with each other but yet still co-operate or interact with each other.

Embodiments described herein are intended to cover any adaptations or variations of the present invention. Although the present invention has been described and explained in terms of particular exemplary embodiments, one skilled in the art will realize that additional embodiments can be readily envisioned that are within the scope of the present invention.

1. A method of generating a narrative design framework, the method including the steps:
receiving a plurality of text strings corresponding to nouns indicative of components of the narrative design;
populating a noun database with the text strings and associating each text string with noun metadata including a text descriptor for the nouns, a unique noun identifier and a noun classification, wherein each text string and associated noun metadata collectively form a noun entry;
creating one or more data objects corresponding to events and/or goals and populating the one or more data objects with at least one of the noun entries to associate the noun entries with one or more events and/or goals;
in response to input from a user, linking one or more events and/or goals with other events and/or goals by creating a link ID and storing each link ID in metadata associated with the respective data objects corresponding with the one or more events and/or goals; and
based on the linked events and/or goals, generating a narrative design framework for creating a narrative.

2. The method according to claim 1 wherein the generated narrative design framework includes a structured text.

3. The method according to claim 1 wherein the linking of an event/goal with another event/goal generates a text sentence.

4. The method according to claim 2 wherein the structured text includes a series of linked text sentences.

5. The method according to claim 1 wherein the generated narrative design framework includes a behaviour tree.

6. The method according to claim 1 wherein the generated narrative design framework includes a finite state machine.

7. The method according to claim 1 wherein the generated narrative design framework is in a machine readable form to be input to a Goal Oriented Action Planning system.

8. The method according to claim 1 wherein the generated narrative design framework is in a machine readable form to be input to a Hierarchical Task Network planning system.

9. The method according to claim 1 wherein at least some of the noun metadata is dynamically variable.

10. The method according to claim 9 wherein at least some of the metadata associated with the respective data objects corresponding with the one or more events and/or goals is dynamically variable.

11. The method according to claim 10 including the step of inputting the narrative design framework to a rules engine which is configured to selectively adjust one or more of the dynamically variable noun metadata and/or event/goal metadata to update the narrative design framework.

12. The method according to claim 11 wherein the rules engine selectively adjusts one or more of the dynamically variable noun metadata and/or event/goal metadata in response to user input.

13. The method according to claim 11 wherein the rules engine selectively adjusts one or more of the dynamically variable noun metadata and/or event/goal metadata based on a set of predefined rules or constraints.

14. The method according to claim 1 wherein the components of the narrative design include one or more of characters, locations, populations, physical objects, or abstract concepts.

15. The method according to claim 1 wherein the plurality of text strings are received via a text import process which imports text from a script and extracts nouns.

16. The method according to claim 15 wherein the plurality of text strings are extracted from a file containing the script.

17. The method according to claim 16 wherein the file is a PDF file.

18. The method according to claim 1 wherein the plurality of text strings are entered by a user through a user interface.

19. The method according to claim 1 including the step of displaying the narrative design framework on a display.

20. The method according to claim 19 including the step of displaying the one or more events and/or goals associated with the narrative design framework on the display and selectively allowing user input to adjust a temporal order of events and/or a value of goals.

21. The method according to claim 19 including the step of generating a visual representation of one or more characters in the form of a relational graph and illustrating the relative position of each character on the graph.

22. The method according to claim 1 including the step of creating one or more noun links which link one or more of the noun entries.

23. A non-transitory machine-readable storage medium storing instructions that, when executed, perform the method according to claim 1.

24. A system including one or more processors and memory storing instructions that, when executed by the one or more processors, perform the method according to claim 1.

25. A computer program including a series of instructions or rules that, when executed by one or more processors, perform the method according to claim 1.
